(19) United States
(12) Patent Application Publication
(10) Pub. No.: US 2007/0203652 A1
(43) Pub. Date: Aug. 30, 2007

(54) Method Of Improving A Mass Spectrum

(76) Inventors: Stevan Roy Horning, Delmenhorst (DE); Oliver Lange, Bremen (DE); Robert Malek, Lilienthal (DE); Andreas Wieghaus, Bremen (DE)

Correspondence Address: THERMO FINNIGAN LLC, 355 RIVER OAKS PARKWAY, SAN JOSE, CA, 95134, US

(21) Appl. No.: 10/592,745

(22) PCT Filed: Mar. 24, 2005
(86) PCT No.: PCT/EP05/03367

§ 371 Date: Sep. 13, 2006

(30) Foreign Application Priority Data
Mar. 26, 2004 (GB) 0406880.5

(51) Int. Cl. G06F 19/00

(52) U.S. Cl. 702/19; 702/22

(57) ABSTRACT

The present invention provides a method of improving a mass spectrum collected from a mass spectrometer comprising a detector for collecting a mass spectrum from ions stored in or released from an ion trapping volume, wherein assignment of masses to peaks appearing in the mass spectrum is sensitive to an experimental parameter related to the mass spectrometer or the operation thereof, such as ion abundance, the method comprising: determining a positional value of a peak; determining the experimental parameter associated with the mass spectrum; comparing the determined positional value with positional values of peaks contained in a calibration dataset; and improving the determined positional value of the peak from adjacent peak positional values by interpolation thereby to provide a corrected mass assignment for the peak. The present invention also provides a method of calibrating such a mass spectrometer.

### FIELD OF THE INVENTION

This invention relates to improving a mass spectrum collected using a mass spectrometer that traps ions within a trapping volume where assignment of masses to peaks within the mass spectrum is sensitive to the ion abundance in the trapping volume.

In particular, this invention relates to improving a mass spectrum collected where the ion abundance in the trapping volume is controlled using automatic gain control.

### BACKGROUND OF THE INVENTION

Mass spectrometry is a mature science and is widely used in the detection and identification of molecular structures and the study of chemical and physical processes. A variety of different techniques are known for the generation of mass spectra using various trapping and detection methods. These techniques include ion trap mass spectrometry, time of flight mass spectrometry (TOF-MS) including quadrupole TOF-MS(QTOF-MS), and Fourier Transform mass spectrometry (FTMS) including FT-ion cyclotron resonance MS (FT-ICR-MS) and FT-Orbitrap-MS (FT-O-MS). Details of an Orbitrap system can be found in U.S. Pat. No. 5,886,346. The other techniques mentioned above are well known to those skilled in the art.

One technique to which the present invention is particularly suited is Fourier Transform ion cyclotron resonance mass spectrometry (FT-ICR-MS). Ions of a sample to be analysed having a mass to charge ratio within a desired range are trapped within a cell using electrodes supplied with appropriate DC and RF voltages. According to the principle of a cyclotron, ions stored within a cell are excited by the RF voltage to move in a spiral path within the cell. The ions orbit as coherent bunches along the same radial paths but at different frequencies, the frequency of the circular motion (the cyclotron frequency) being proportional to the ion mass.

A set of detector electrodes may be provided within the cell. An image current is induced in these detector electrodes by the coherent orbiting ions. The amplitude of each frequency component within the detected current signal (often referred to as the “transient”) is indicative of the abundance of ions having the mass corresponding to that frequency. Hence, performing a Fourier Transform of the transient produces a mass spectrum of the ions trapped within the cell.

Ion traps use an alternative detection process. In two-dimensional or three-dimensional ion traps, the DC and RF voltages may be adjusted between preset limits to decrease the range of frequencies and hence charge to mass ratios that produce trapped ions. This causes ions with progressively changing mass to charge ratios to become unstable and so exit the cell. The number of unstable ions are detected as they leave the trap for each DC and RF voltage setting and their mass is identified by these DC and RF voltages.

Both methods suffer from a problem in that they are sensitive to the total number of ions introduced and trapped within the volume, be it an ion cell or an ion trap. Clearly, it is desirable to accumulate as many ions as possible in the volume, in order to improve the statistics of the collected data. However, this desideratum is in conflict with the fact that there is saturation at higher ion concentrations that produces space charge effects. These space charge effects limit mass resolution and cause shifts in the mass to frequency relationship, thereby leading to incorrect assignment of masses and even intensities. Two techniques are known that address this problem of an over-abundance of ions in the cell.

The first technique is generally referred to as automatic gain control. The total ion abundance within the cell is controlled by making a rapid total ion abundance measurement prior to performing a high-resolution mass spectrometry scan. Knowledge of the ionisation time and the total ion abundance allows selection of an appropriate ionisation time before each high-resolution scan to create an optimum ion abundance in the cell. This technique is described in further detail in U.S. Pat. No. 5,107,109. Whilst this approach has enjoyed some success, it is prone to mediocre ion abundance prediction particularly where experimental conditions are liable to change quickly as in fast chromatography, unstable ionisation or pulsed ion desorption methods.

Rather than to try to control precisely the ion abundance within the cell as in the first technique, the second technique attempts to correct for mass assignment errors caused by too high an ion abundance in the cell. This is achieved by performing a calibration to determine how assigned masses vary with ion abundance. The ion abundance can be determined by various methods, such as using sidebands of peaks seen in the mass spectra (see for example U.S. Pat. No. 4,933,547). A useful implementation of this technique is to perform a calibration to solve the equation

$$m = \frac{A}{f} + \frac{B}{{f}^{2}} \qquad eq . ( 1 )$$

where m is the assigned mass, f is the cyclotron frequency of the ions and A and B are coefficients corresponding to complex functions depending on such parameters as the magnitude of DC and AC voltages, space charge and the magnetic environment. This correction technique suffers from problems in that the calibration laws tend to be complex, leading to amelioration of spectral quality even where any errors in predicting parameters is small (a manifestation of the so-called “butterfly effect”). In addition, without careful regulation there are always spectra interspersed between the calibration points that cannot be corrected to any degree of satisfaction.

Thus, there is a need for an improved method of producing mass spectra where the adverse effects of too high an ion abundance are minimised.

### SUMMARY OF THE INVENTION

According to a first aspect, the present invention resides in a method of improving a mass spectrum collected from a mass spectrometer comprising a detector for collecting a mass spectrum from ions stored in or released from an ion trapping volume, wherein assignment of masses to peaks appearing in the mass spectrum is sensitive to an experimental parameter related to the mass spectrometer or the operation thereof, the method comprising the steps of: determining a positional value of at least one peak of the mass spectrum; determining the experimental parameter associated with the mass spectrum; comparing the determined positional value with positional values of peaks contained in a calibration dataset that contains positional values for varying values of the experimental parameter; and improving the determined positional value of the peak from adjacent peak positional values by interpolation thereby to provide a corrected mass assignment for the peak.

This method may be used with more than one experimental parameter provided the calibration dataset contains peak positional values for each type of experimental parameter. The experimental parameter may relate to the trapping volume of the operation thereof. An example of the experimental parameter may be the ion abundance in the trapping volume.

The positional value may correspond to a number of parameters. For example, the peak position may correspond to a position on a scale (e.g. if the spectrometer collected readings at 1000 intervals, the number used may merely be the position within this interval) to the frequency of the signal corresponding to the peak (as the mass spectrometer is likely to measure signal intensities as frequencies and relate the frequency to a mass) or to a mass assigned to that peak. The method above would work equally well using any of these schemes and so the implementation can be chosen freely.

In addition, the positional values may be coefficients of an equation linking the frequency of a peak to the mass of that peak. In certain spectrometers, the equation may be of the form

$$m = \frac{A}{f} + \frac{B}{{f}^{2}} ,$$

where m is the assigned mass, f is the frequency of the measured signal for the corresponding peak and A and B are coefficients or functions. This formula works well for FT-ICR-MS, for example. The calibration data set may be collated to comprise coefficients A and B for peak positions or values of the experimental parameter recorded therein. Then, the step of interpolating the position of the peak from adjacent peak positions may comprise calculating coefficients A′ and B′ by interpolation between coefficients A and B stored for the adjacent peak positions or for adjacent values of the experimental parameter and substituting the coefficients A′ and B′ into the equation

$$m = \frac{{A}^{′}}{f} + \frac{{B}^{′}}{{f}^{2}}$$

to obtain the corrected mass.

Calibrating a data set allows peak positions to be improved by referencing to an adjacent calibrated peak position and adjusting using interpolation. Clearly, the quality of the corrected masses so achieved depends upon the size of the calibration data set because the approximation achieved by using interpolation worsens as the distance between adjacent calibration points increases.

Various types of interpolation schemes may be chosen according to the particular experiment. As examples, linear, cubic spline, B-spline, Akima, Thiele or rational interpolations are all schemes that may be suitable. Statistical variations may be flattened out, where deemed necessary or desirable, using well known approximation schemes like least squares fitting or the Chebyshev approximation.

Preferably, the steps described above may be preceded by filling the trapping volume with ions according to a target ion abundance determined in accordance with automatic gain control and acquiring the mass spectrum from the ion stored in or released from the ion trap so filled. This is advantageous as the effects of incorrect mass assignment are minimised in the first instance, and so the interpolation used according to the first aspect of the present invention need only make a small correction.

Optionally, determining the target ion abundance with automatic gain control comprises: filling the trapping volume for a predetermined time; measuring the total ion content of the trapping volume so filled; and comparing the measured total ion content to the target ion abundance and calculating an adjusted predetermined time to achieve the target ion abundance and wherein filling the trapping volume with ions according to a target ion abundance determined in accordance with automatic gain control comprises filling the trapping volume for the adjusted predetermined time.

From a second aspect, the invention resides in a method of calibrating a mass spectrometer comprising a detector for collecting a mass spectrum from ions stored in or released from an ion trapping volume, wherein assignment of masses to peaks appearing in the mass spectrum is sensitive to an experimental parameter related to the mass spectrometer or the operation thereof, the method comprising the steps of: filling the trapping volume according to a first value of the experimental parameter; acquiring a mass spectrum of ions in the trapping volume; repeating filling the trapping volume to further values of the experimental parameter and acquiring a mass spectrum of ions in the trapping volume for at least one further value, thereby acquiring an array of calibration mass spectra; determining positional values of at least one peak of the calibration mass spectra; and storing in a calibration data set positional values with the varying values of the experimental parameter.

This method may be repeated for one or more other experimental parameters.

Optionally, the positional values are masses assigned to a peak. Alternatively, the positional values may be frequencies of a peak. A further alternative is where the positional values are coefficients of an equation linking the frequency of a peak to the mass of that peak. The equation is

$$m = \frac{A}{f} + \frac{B}{{f}^{2}} ,$$

where m is the mass, f is the frequency, and A and B are the coefficients; the calibration data set comprising values for both coefficients A and B for different values of the experimental parameter.

Optionally, the experimental parameter is one of: the ion abundance in the trapping volume, the temperature in the trapping volume, AC potentials applied to the trapping volume or DC potentials applied to the trapping volume.

Preferably, filling the trapping volume with ions is performed according to a target ion abundance determined in accordance with automatic gain control; and the mass spectrum is acquired from the ions stored in or released from the ion trap so filled. Conveniently, determining the target ion abundance with automatic gain control comprises: filling the trapping volume for a predetermined time; measuring the total ion content of the trapping volume so filled; and comparing the measured total ion content to the target ion abundance and calculating an adjusted predetermined time to achieve the target ion abundance and wherein filling the trapping volume with ions according to a target ion abundance determined in accordance with automatic gain control comprises filling the trapping volume for the adjusted predetermined time.

The above method of calibrating a mass spectrometer described above, as modified by any of the optional features and any combination thereof, may be combined with the method of improving a mass spectrum described above, as modified by any of the optional features and any combination thereof.

From a third aspect, the present invention resides in a mass spectrometer comprising an ion trapping volume, a detector for collecting a mass spectrum from ions stored in or released from an ion trapping volume, and a processor operable to assign masses to peaks appearing in the mass spectrum, wherein assignment of masses to peaks appearing in the mass spectrum is sensitive to an experimental parameter related to the mass spectrometer or the operation thereof, the processor being programmed to perform any of the methods described above.

The present invention also extends to a computer program comprising program instructions operable when loaded into a mass spectrometer comprising an ion trapping volume, a detector for collecting a mass spectrum from ions stored in or released from an ion trapping volume, and a processor operable to assign masses to peaks appearing in the mass spectrum, wherein assignment of masses to peaks appearing in the mass spectrum is sensitive to an experimental parameter related to the mass spectrometer or the operation thereof, to cause the processor to perform any of the methods described above.

The present invention also extends to a computer program product comprising a computer readable medium having thereon program instructions operable when loaded into a mass spectrometer comprising an ion trapping volume, a detector for collecting a mass spectrum from ions stored in or released from an ion trapping volume, and a processor operable to assign masses to peaks appearing in the mass spectrum, wherein assignment of masses to peaks appearing in the mass spectrum is sensitive to an experimental parameter related to the mass spectrometer or the operation thereof, to cause the processor to perform any of the methods described above.

### BRIEF DESCRIPTION OF THE DRAWINGS

Examples of the invention will now be described with reference to the accompanying drawings, in which:

FIG. 1 is a schematic illustration of an apparatus implementing a method for improving mass spectra;

FIG. 2 is a flow diagram illustrating a method of controlling ion populations in a mass analyser;

FIG. 3 is a graph illustrating how a complex curve can be approximated to a linear relationship around a point of interest;

FIG. 4 is a flow diagram showing a calibration scheme; and

FIG. 5 is a flow diagram showing a scheme for collecting mass spectra and correcting mass assignment of peaks contained therein.

### DESCRIPTION OF PREFERRED EMBODIMENTS

As illustrated in FIG. 1, an apparatus/system 100 that can be used to improve mass spectra obtained by a mass analyzer 130 includes an ion source 115 in communication with an ion accumulator 120 (with associated ion accumulator electronics 150), a detector 125 (with associated detector electronics 155), and the mass analyzer 130. Some or all of the components of system 100 can be coupled to a system control unit, such as an appropriately programmed digital computer 145, which receives and processes data from the various components and which can be configured to perform analysis on data received.

Ion source 115, which can be any conventional ion source such as an ion spray or electrospray ion source, generates ions from material received from, for example, an autosampler 105 and a liquid chromatograph 110. Ions generated by ion source 115 proceed (directly or indirectly) to ion accumulator 120. Ion accumulator 120 functions to accumulate ions derived from the ions generated by ion source 115. As used in this specification, ions “derived from” ions provided by a source of ions include the ions generated by source of ions as well as ions generated by manipulation of those ions. The ion accumulator 120 can be, for example, in the form of a multipole ion guide, such as a RF quadrupole ion trap or a RF linear multipole ion trap, or a RF “ion tunnel” comprising a plurality of electrodes configured to store ions and having apertures through which ions are transmitted. Where ion accumulator 120 is a RF quadrupole ion trap, the range and efficiency of ion mass to charge (m/z's) captured in the RF quadrupole ion trap may be controlled by, for example, selecting the RF and DC voltages used to generate the quadrupole field, or applying supplementary fields, e.g. broadband waveforms. A collision or damping gas is preferably introduced into the ion accumulator in order to enable efficient collisional stabilization of the ions injected into the ion accumulator 120.

In the implementation illustrated in FIG. 1, ion accumulator 120 can be configured to eject ions towards detector 125, which detects the ejected ions. Detector 125 can be any conventional detector that can be used to detect ions ejected from ion accumulator 120. In one implementation, detector 125 can be an external detector, such as an electron multiplier detector or an analogue electrometer, and ions can be ejected from ion accumulator 120 in a direction transverse to the path of the ion beam towards the mass analyser 130.

Ion accumulator 120 can also be configured to eject ions towards mass analyzer 130 (optionally passing through ion transfer optics 140) where the ions can be analyzed in analysis cell 135. The mass analyzer 130 can be any conventional trapping ion mass spectrometer, such as a three-dimensional quadrupole ion trap, an RF linear quadrupole ion trap mass spectrometer, an Orbitrap, an ion cyclotron resonance mass spectrometer or a time-of-flight (TOF) detector.

FIG. 2 illustrates a method 200 of controlling ion population in a mass analyzer 130 in apparatus 100. The method begins with a pre-experiment, during which ions are accumulated in ion accumulator 120 (step 210), and detected in detector 125 (step 220). Ions are generated in the ion source 115 as described above. Ions derived from the generated ions are accumulated in ion accumulator 120 over the course of a predetermined sampling interval (e.g., by opening ion accumulator 120 to a stream of ions generated by ion source 115 for a time period corresponding to a predetermined sampling interval). The duration of the sampling interval can depend on the particular ion accumulator in question, and will generally be any relatively short time interval that is sufficient to supply the ion accumulator 120 with enough ions for the subsequent detection and determination steps of the pre-experiment. For example, a typical RF multipole linear ion trap will be filled to capacity with ions generated by an electrospray ionization source over a time of 0.02 ms to 200 ms or more. Thus, an appropriate sampling time interval for such an accumulator might be in the region of 0.2 ms.

Substantially all the accumulated ions are then ejected from ion accumulator 120 and at least a portion of the ejected ions are passed to detector 125. Any ions remaining in the ion accumulator 120 should be ejected therefrom before ions are next accumulated in the ion accumulator 120.

The ejected ions are detected by the detector 125 that generates an ejected ion signal. This signal is used to determine an injection time interval (step 230). The injection time interval represents the amount of accumulation time that will be required to obtain a predetermined population of ions that is expected to be optimum for the purpose of a subsequent experiment, as will be described in more detail below.

The injection time interval can be determined from the ejected ion signal and the predetermined sampling interval by estimating the ion accumulation rate in the ion accumulator 120, i.e. by estimating the ion population trapped in the ion accumulator 120 during the sampling time interval. From this estimated accumulation rate (assuming a substantially continuous flow of ions), one can determine the time for which it will be necessary to inject ions into the ion accumulator 120 in order ultimately to produce the final population of ions that is subsequently analyzed by the mass analyzer 130.

Ions are then accumulated in the ion accumulator 120 for a period of time corresponding to the determined injection time interval (step 240). These accumulated ions are subsequently transferred to the mass analyzer 130 for analysis (step 250).

As discussed above, the injection time interval represents the period of time for which ions must be supplied to the ion accumulator 120 such that the accumulator accumulates an optimum population of ions (after initial processing or manipulations) that optimises the performance of the ion accumulator 120 or the apparatus 100 as a whole.

Optimum performance in this case relates to avoiding excessive space charge or detector saturation that will otherwise produce spurious data during mass spectra collection. Increasing the population of ions too far can lead to space charge problems that cause individual ions to experience a shift in frequency. This frequency shift can be a localised frequency shift or a bulk frequency shift, either of which can result in deterioration in m/z assignment accuracy. At higher charge levels, peaks close in frequency (m/z) will coalesce either fully or partially. This can be of particular concern when dealing with a population of ions that are close in isotopic mass.

In order to accumulate ions for the determined injection time interval, the ion accumulator 120 may need to be filled only partially or filled more than once. That is, the ion accumulator 120 may be opened to the stream of ions from ion source 115 for a time period less than the time required to fill the ion accumulator 120 to its full capacity. Alternatively, it may be necessary to fill the ion accumulator multiple times in order to accumulate ions for the determined injection time interval (e.g., if the accumulator cannot accommodate the amount of ions that would be introduced from the ion source 115 during the full injection time interval). In this case, the accumulated ions can be stored elsewhere (for example, in a further ion trap upstream of the ion accumulator 120) until the desired secondary accumulator population is reached.

Thus, an injection time interval is determined from the ion accumulation rate and from the optimum ion filling conditions associated with the apparatus 100. The optimum population may relate to either the charge density (that takes into consideration both the number of charges and the actual charge on each ion) or the ion density (that takes into consideration the number of ions and assumes that the charge associated with every selected ion is the same, usually one).

The determination of the injection time interval can be simply based on the detected ion charge (integral of detected ion current):

$${T}_{{injection}_{optimal}} = \frac{{Q}_{{measured}_{optimal}}}{{Q}_{{measured}_{pre \text{-} experiment}}} \times {T}_{{injection}_{pre \text{-} experiment}}$$

where T represents time and Q represents the ion charge (integral of the detected ion current) measured. Restrictions or limitations imposed by the ion accumulator 120 and the mass analyzer 130 may dictate whether the optimal ion population (i.e. the population of ions that will be accumulated over the course of the injection time interval) corresponds to an optimum population of ions in the ion accumulator 120, or an optimum population of ions in the analysis cell 135 of the mass analyzer 130.

By regulating the population of ions in the ion accumulator 120, and/or in the analysis cell 135 in the mass analyzer 130, the apparatus 100 can be tuned to operate at optimum capacity. That is, accumulating ions only for the determined injection time interval results in an ion population that will fill either the ion accumulator 120 or the analysis cell 135 in the mass analyzer 130 to its maximum capacity that will not saturate that device (i.e., that will not result in undesirable space charge effects).

The final population of trapped ions in the analysis cell 135 can be m/z analyzed in a number of known ways. For example, in an FT-ICR method, trapped ions are excited so that their cyclotron motion is enlarged and largely coherent (such that ions of the same m/z have cyclotron motion that is nearly in phase). This radial excitation is generally accomplished by superposing AC voltages onto the electrodes of the analysis cell 135 so that an approximate AC electrostatic dipole field (parallel plate capacitor field) is generated. Once the ions are excited to have large and substantially coherent cyclotron motion, excitation ceases and the ions are allowed to cycle (oscillate) freely at their natural frequencies (mainly cyclotron motion). If the magnetic field is perfectly uniform and the DC electrostatic trapping potential is perfectly quadrupolar (a homogeneous case, with no other fields to consider), then the natural frequencies of the ions are wholly determined by the field parameters and the m/z of the ions. To a good first order approximation in these circumstances, the frequency

$$f = \frac{B}{m / ze} .$$

The oscillating ions induce image currents in (and corresponding small voltage signals on) the electrodes of the cell 135. These signals are (with varying degrees of distortion) analogue to the motion of the ions in the cell 135. The signals are amplified, digitally sampled, and recorded. This time domain data, through well known signal processing methods (such as DFT, FFT), are converted to frequency domain data (a frequency spectrum). The amplitude-frequency spectrum is converted to an amplitude-m/z spectrum (mass spectrum) based on a previously determined f to m/z calibration. The intensities of the peaks in the resulting spectrum are scaled by the total time of ion injection (over all “fills” of the ion accumulator) used to provide samples from which the spectrum is generated. Thus the resulting m/z spectrum of the final m/z analysis population of trapped ions in the analysis cell 135 has intensities that are in proportion to the rate at which these ions are produced in the ion source and delivered to the ion accumulator 120.

Further details of such an apparatus and its method of operation to provide automatic gain control can be found in our co-pending U.S. patent application Ser. No. 10/763,401.

Accordingly, the apparatus 100 can be operated using automatic gain control to achieve an ion abundance in the trapping volume that is as close as possible to the ideal. However, as mentioned previously, the ion abundance achieved is likely to drift from the ideal. Any variation may lead to space charge effects and a drift in the values assigned to masses from the correct values. This drift can be corrected for as will now be described.

The correction method employed is a simplification of the calibration method described above. Previously, correction by calibration has been performed in isolation, and so a full calibration has been required to correct for wide variations in experimental parameters to allow for correction using complex mathematical relationships. However, the applicant has appreciated that using automatic gain control means that the ion abundance will at least be close to the optimum and so only minor corrections need be made.

Rather than calibrating to determine the complex functions that describe the coefficients A and B that appear in equation (1)

$$m = \frac{A}{f} + \frac{B}{{f}^{2}}$$

mentioned above, the invention solves the above equation by using the fact that most relevant physical functions (i.e. functions for which the second derivative exists) can be approximated to a linear function over a small region. The use of automatic gain control ensures that this approximation works well as the variation in assigning masses will deviate only slightly, i.e. over only a small region. Accordingly, linear approximations can be used to determine the coefficients A and B, and masses can then be corrected far more simply using equation (1).

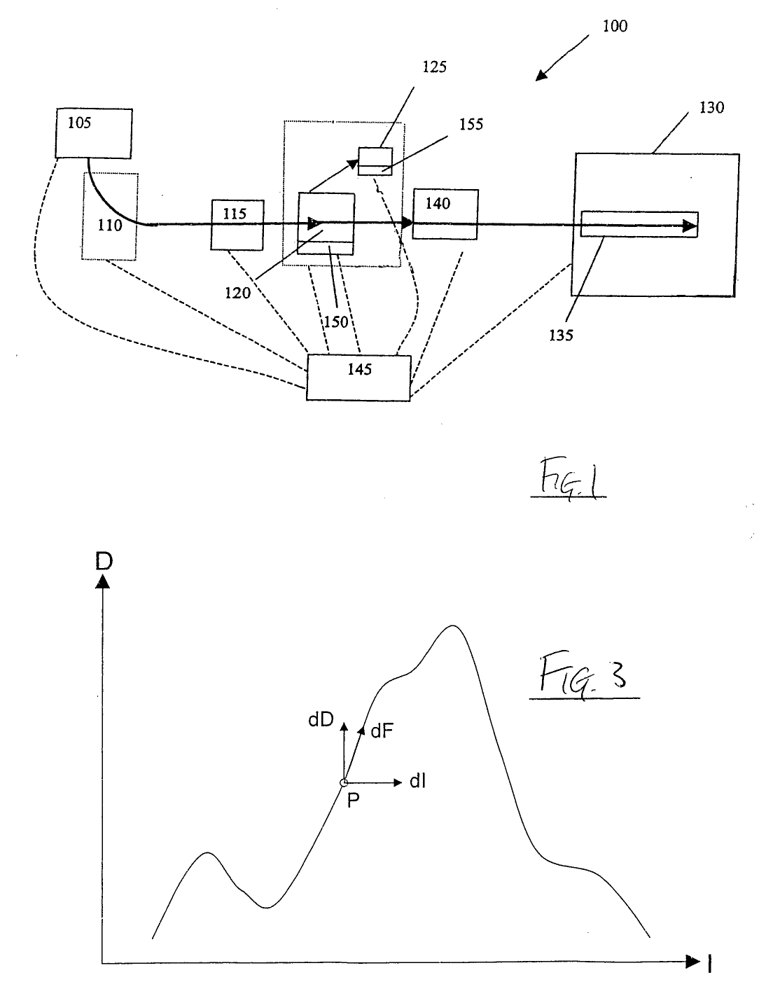

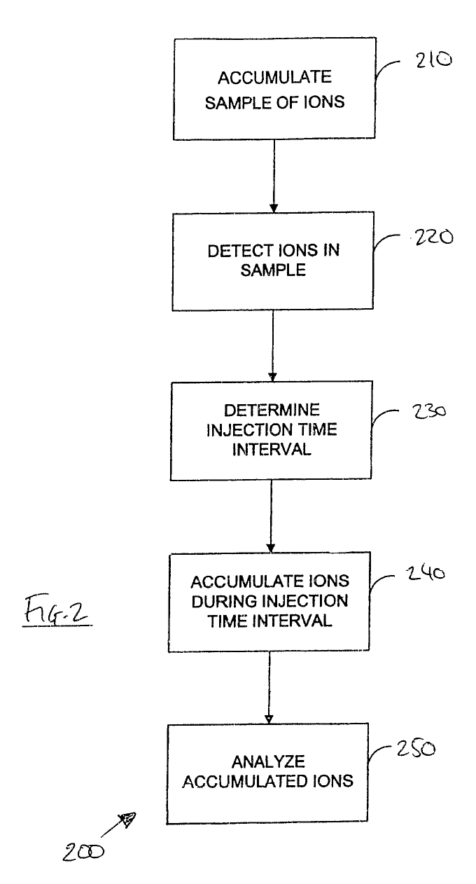

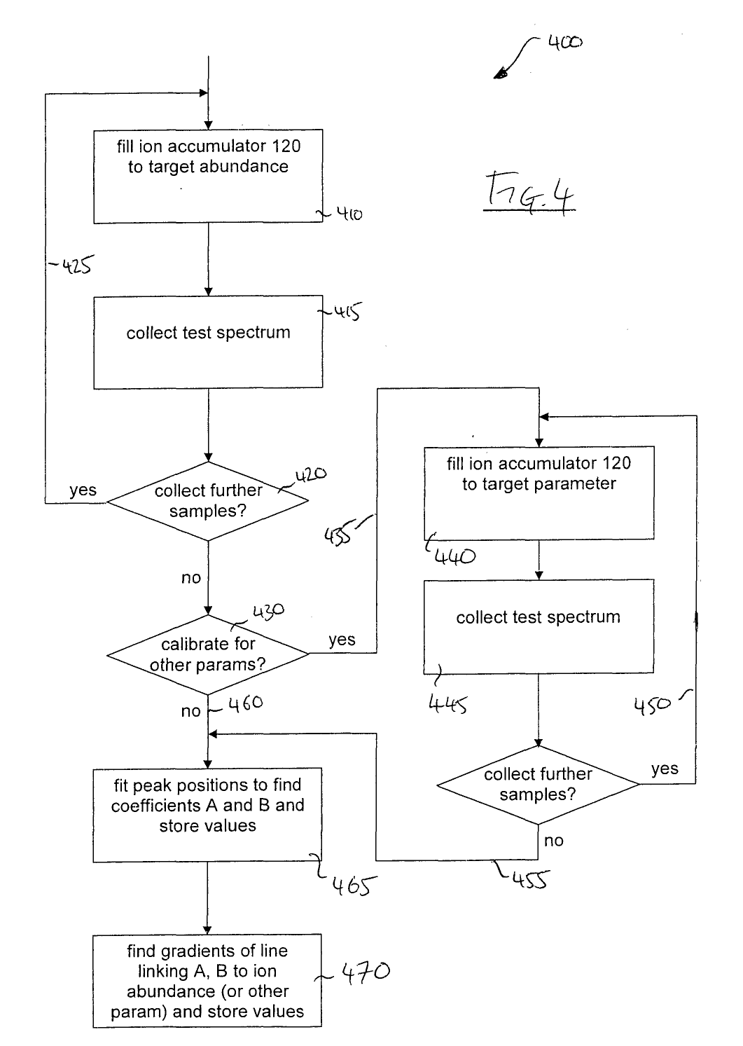

This linear behaviour is illustrated in FIG. 3 where a physical function F relating an independent variable I to a dependent variable D is shown. For a small region around the point of interest P, the function F varies in a linear fashion as can be determined by taking the first derivative dF=dD/dI.

Applying this to mass spectrometry using automatic gain control as described above, the measured mass m of an ion as a function of the amount a of ions in the trap can be approximated by

$$m = {m}_{0} + \frac{ⅆ m}{ⅆ a} \qquad eq . ( 2 )$$

where m₀ is the mass at the point P, i.e. the true mass for the intended optimum ion abundance. This true mass m₀ can be determined by calibration prior to collection of the experimental data of interest.

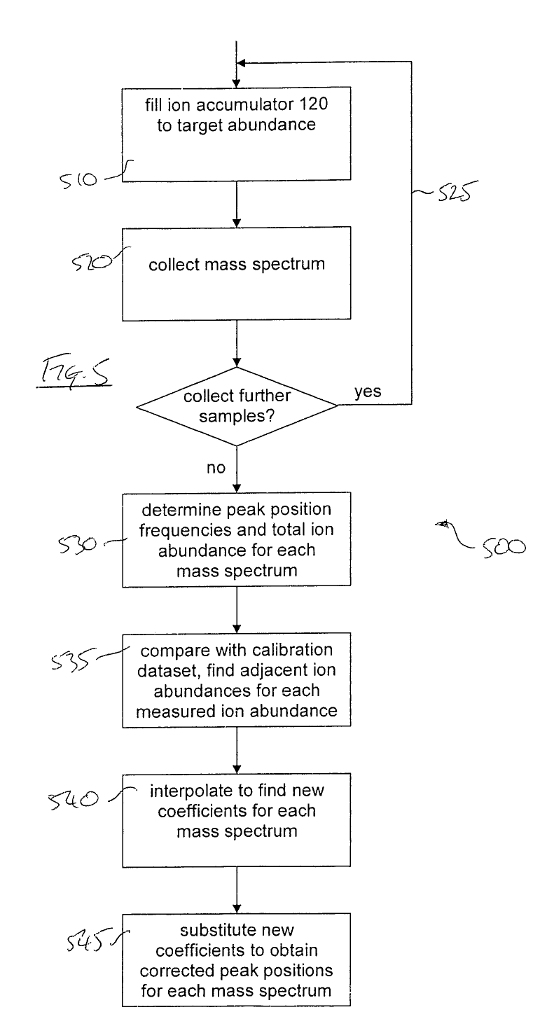

In this embodiment, calibration is performed according to the following scheme 400 that is shown in FIG. 4.
(1) At 410, a packet of ions from a test sample is introduced into (or generated in) the ion accumulator 120. Usually, but not necessarily, the masses (m/z) of the ions cover a certain mass region of interest. Test samples will have a well known mass spectrum signature, i.e. the true masses corresponding to the peaks in the mass spectrum will be known to high accuracy. In addition, test samples are generally selected for convenience according to such criteria as providing useful mass range, having ease of ionisation, and a long shelf life.
(2) At 415, a test mass spectrum is collected (i.e. a mass spectrum comprising a number of peaks of differing intensities at a number of different masses) after the ion accumulation has been allowed to continue for the injection time interval as determined by the automatic gain control procedure 200 described above, thereby producing a first ion abundance that should correspond to the optimum.
(3) The ion accumulator 120 is repeatedly refilled using different ionisation times to produce ion abundances spaced around the optimum. Accordingly, at 420 a decision is made whether or not to collect further sample spectra. Further test mass spectra are collected by following loop 425 such that spectra are collected after each trap fill to form a calibration data set. The calibration data set hence comprises a series of peak positions (i.e. the assigned masses) for each ion abundance. Each peak's position will vary slightly as the ion abundance varies. This data can be visualised as a series of lines on a graph of mass (i.e. peak position) versus ion abundance, each line corresponding to a number of points showing how the position of a particular peak within the mass spectra varies according to the different ion abundances.
(4) At 430, further test mass spectra are, optionally, collected after varying some of the other experimental parameters using loop 435. For example, test mass spectra are collected for both polarities to calibrate for positive and negative ions separately, and over different mass ranges. Additionally, calibrations are performed for different resolution settings, e.g. by using different DC trapping potentials. The ion accumulator 120 is filled at 440 and each test spectrum is collected at 445, akin to the steps 410 and 415. In addition, a loop 450 akin to loop 425, allows multiple spectra to be collected. Hence, the complete calibration data set contains a multi-dimensional description of how each peak within a dataset's position varies with any number of experimental parameters. This is saved as an array of data, each set of data within the array containing data that describe the points obtained for the peak's position as it varies with one of the experimental parameters (e.g. a set of data to create the graph showing the points that describe the variation of peak position with ion abundance, another set to show the points of peak position versus DC potential, etc.).

When all calibration spectra are collected, the scheme proceeds via paths 455 or 460.
(5) At 465, the peak positions found above are analysed by the computer 145 using equation (1) to derive calibration coefficients A and B for each peak. These values are averaged to determine single values for A and B for the corresponding ion abundance. These values are stored in the calibration data set along with the ion abundance and each peak's position.
(6) At 470, the complete calibration data set is analysed to determine the gradient of the line linking each pair of adjacent points within each set of data that relate coefficients A and B to ion abundance. These gradients are also stored in the data set in this embodiment although, in other contemplated embodiments, this stage is not performed as part of the calibration process and is instead performed “on the fly” during later data collection and analysis.

Hence, the calibration data set in this example provides a look-up table containing the peak position and hence its assigned mass m₀, along with the ion abundance, coefficients A and B and optionally, gradients. Hence, a mass for a value (e.g. ion abundance) between the measured values can be found by interpolation using equations (1) and (2) above.

With calibration complete, experimental data can be collected in the usual fashion. Specifically, the ion accumulator 120 is filled to an optimum ion abundance as determined according to the automatic gain procedure described above. Raw mass spectra are then obtained that will contain a series of peaks that relate intensity to frequency and hence an assigned mass. The raw mass spectra so collected may be analysed such that the assigned masses are corrected. This process is shown at 500 of FIG. 5 and will now be described in more detail.
(1) At 510, the ion accumulator 120 is filled to try to achieve a target ion abundance corresponding to the optimum abundance determined through automatic gain control. In practice, experimental inaccuracies will prevent this target being achieved.
(2) At 520, a mass spectrum is collected that will have peaks at certain frequency positions corresponding to raw assigned masses, and a total count corresponding to the ion abundance within the ion accumulator 120.
(3) Further mass spectra may be collected after successively filling the ion accumulator 120 by following loop 525 as many times as required.
(4) When all spectra have been collected, the scheme proceeds to 530 where the computer 145 determined the frequencies corresponding to each peak's position and also determines the total ion abundance for each spectrum.
(5) At 535, the measured ion abundance for each spectrum is compared against those stored in the calibration data set to determine between which calibration spectra it lies.
(6) At 540, equation (2) is used to interpolate between the stored coefficients A and B to determine coefficients A′ and B′ that correspond to the actual ion abundance.
(7) At 545, the corrected coefficients A′ and B′ are substituted into equation (1) to derive corrected masses for the peaks in the mass spectrum.

Thus, mass spectra may be improved using the above method that combines automatic gain control to set a desired ion abundance and mass correction through calibration to account for variations about this desired abundance.

The method may be extended by setting a plurality of optimum ion abundances, i.e. calibrating about a number of target ion abundances according to different experimental conditions (e.g. different samples to be analysed). Accordingly, further data arrays containing points and gradients may be measured for each of these target ion abundances. When performing subsequent mass spectra collection, the assigned masses may be corrected by choosing the appropriate calibration data from the target ion abundances.

In some circumstances, the target ion abundance may not be achievable. For example, a mass spectrometer may have a maximum fill time that cannot be exceeded (say 100 ms). This may mean that a target ion abundance is not reached within this maximum fill time, such that there is an “underfill”. This underfill ratio can be calculated (say 60%). The target ion abundance is then scaled accordingly and used in steps (4) and (5) above. So, if the target ion abundance was 1×10⁶, then a revised target ion abundance of 0.6×10⁶ is used if the underfill ratio is 60%.

### EXAMPLES

In order that the present invention may be better understood, an example is now presented in the context of FT-ICR-MS. Calibration is executed by collecting test spectra at a series of six different target ion abundances T of 2×10⁵, 5×10⁵, 1×10⁶, 2×10⁶, 5×10⁶ and 1×10⁷. These values are chosen as they are centred around an optimum ion abundance of 2×10⁶. For the sake of simplicity, we will assume that each test spectrum contains only two peaks, at masses 300 and 1700. The test spectra are analysed to produce the following table that contains the target abundance T, the measured abundance I, and the peak frequencies F1 and F2. Equation (1) is used to find coefficients A and B and gradients are calculated.

| | | | | | | | gradient | |
|---|---|---|---|---|---|---|---|---|
| | | | freq | | coeffs | | SX = (Xᵢ − Xᵢ₋₁)/(Iᵢ − Iᵢ₋₁) | |
| i | targ T | abund I | F1 | F2 | A | B | SA | SB |
| 1 | 2 × 10⁵ | 40000 | 300.003 | 52.938 | 90002 | −350 | — | — |
| 2 | 5 × 10⁵ | 105000 | 300.002 | 52.938 | 90001.9 | −425 | −1.54 × 10⁻⁶ | −1.15 × 10⁻³ |
| 3 | 1 × 10⁶ | 220000 | 300.000 | 52.937 | 90001.7 | −480 | −1.74 × 10⁻⁶ | −4.78 × 10⁻⁴ |
| 4 | 2 × 10⁶ | 430000 | 299.999 | 52.936 | 90001.5 | −540 | −9.52 × 10⁻⁷ | −2.86 × 10⁻⁴ |
| 5 | 5 × 10⁶ | 1020000 | 299.996 | 52.935 | 90001 | −630 | −8.47 × 10⁻⁷ | −1.53 × 10⁻⁴ |
| 6 | 1 × 10⁷ | 1950000 | 299.992 | 52.933 | 90000 | −700 | −1.08 × 10⁻⁶ | −7.53 × 10⁻⁵ |

This table is then used as a lookup reference for subsequent measurements. In this example, a sample that includes a molecule with mass 1500 is to be measured. The automatic gain procedure 200 suggests an ion abundance of 7×10⁵ as optimum. However, as in all experiments, achieving exactly the desired ion abundance is impossible and the achieved ion abundance is 185000.

New values for the coefficients A and B corresponding to an abundance of 185000 above are found by interpolation between adjacent ion abundances using equation (2), namely

$${A}^{′} ≡ ( \frac{{A}_{3} - {A}_{2}}{{I}_{3} - {I}_{2}} ) ( {I}^{′} - {I}_{3} ) + {A}_{3} , \\ {A}^{′} ≡ ( {SA}_{3} ) ( {I}^{′} - {I}_{3} ) + {A}_{3}$$

$${A}^{′} ≡ ( - 1.74 \times {10}^{- 6} ) ( 185000 - 220000 ) + 90001.7 , \\ {A}^{′} ≡ 90001.76$$

$$and$$

$${B}^{′} ≡ ( \frac{{B}_{3} - {B}_{2}}{{I}_{3} - {I}_{2}} ) ( {I}^{′} - {I}_{3} ) + {B}_{3} , \\ {B}^{′} ≡ ( {SB}_{3} ) ( {I}^{′} - {I}_{3} ) + {B}_{3} , \\ {B}^{′} ≡ ( - 4.78 \times {10}^{- 4} ) ( 185000 - 220000 ) - 480 , \\ {B}^{′} ≡ - 463.26$$

Substituting the values found for the coefficients A′ and B′ into equation (1) above produces an assigned mass of 1499.99999 as opposed to the true mass of 1500. Accordingly, the method is accurate to within 0.01 ppm. The prior art method of correcting by solving complex functions for coefficients A and B was found to produce an answer of 1500.00551, an error of 3.67 ppm.

A further example is now presented in the context of a FT-Orbitrap mass spectrometer. Mass assignment is particularly sensitive to total ion abundance and the temperature of the system, and the variation can be represented by the equation

$$m = \frac{B}{{f}^{2}} \qquad eq . ( 3 )$$

where B is a function of both abundance and temperature.

As described before, calibration data is collected. The regulation ion abundance I₀ was 100000, so measurements were formed for abundances of 20000, 50000, 80000, 100000, 150000 and 200000. The regulation temperature T₀ was 300 K, so measurements were performed at temperatures of 298.5 K, 299.0 K, 299,5 K, 300.0 K, 300.5 K, 301.0 K and 301.5 K. Fitting the peaks found according to equation (3) above provided the following calibration data sets.

differences

| i | abund I | coeff B | ΔI | ΔB |
|---|---|---|---|---|
| 1 | 20000 | 1.59997 × 10⁷ | −80000 | −300 |
| 2 | 50000 | 1.59998 × 10⁷ | −50000 | −200 |
| 3 | 80000 | 1.59999 × 10⁷ | −20000 | −100 |
| 4 | 100000 | 1.60000 × 10⁷ | 0 | 0 |
| 5 | 150000 | 1.60003 × 10⁷ | 50000 | 300 |
| 6 | 200000 | 1.60007 × 10⁷ | 100000 | 700 |

differences

| i | temp I | coeff B | ΔT | ΔB |
|---|---|---|---|---|
| 1 | 298.5 | 1.59993 × 10⁷ | −1.5 | −700 |
| 2 | 299.0 | 1.59997 × 10⁷ | −1.0 | −300 |
| 3 | 299.5 | 1.59999 × 10⁷ | −0.5 | −100 |
| 4 | 300.0 | 1.60000 × 10⁷ | 0 | 0 |
| 5 | 300.5 | 1.60001 × 10⁷ | 0.5 | 100 |
| 6 | 301.0 | 1.60003 × 10⁷ | 1.0 | 300 |
| 7 | 301.5 | 1.60007 × 10⁷ | 1.5 | 700 |

When more than more than one regulation property exists (e.g. ion abundance and temperature here), it is efficient to use relative shifts around the regulation points. Hence, ΔI, ΔT and respective ΔB's are shown in the tables. Target abundances and peak positions (frequencies) are not shown for the sake of clarity.

As will be immediately evident from the temperature table, the variation is not linear and so using a linear interpolation will bring only limited accuracy. Instead, a local spline interpolation is used (this technique is well known and be implemented using standard software packages such as Maple™.

Assume a peak corresponding to a mass of 1000 is measured at a frequency of 126.49233, with a measured abundance of 120000 and a measured temperature of 300.8 K. Relative to the regulation points, this gives relative shifts of
ΔI=120000−100000=20000 and
ΔT=300.8−300.0=0.8

Comparing these values to the calibration tables and calculating with the local spline provides correct values of ΔB as
ΔΔB_{corrected}_{_{—}}_{T}=197.600
ΔB_{corrected}_{_{—}}_{I}=110.750
This gives a corrected value of B,

$$\begin{matrix}{B}_{corrected} = {B}_{0} + Δ {B}_{corrected\_T} + Δ {B}_{corrected\_I} \\ = 1.6 \times {10}^{7} + 197.600 + 110.750 \\ = 1.60003 \times {10}^{7}\end{matrix}$$

Substituting this value into equation (3) above gives an assigned mass

$$\begin{matrix}m = \frac{B}{{f}^{2}} \\ = \frac{1.6003 \times {10}^{7}}{{126.49233}^{2}} \\ = 999.9999994\end{matrix}$$

Using the prior art correction achieves an assigned mass of 999.9807279.

We see that the selection of the interpolation scheme could depend on the desired balance between accuracy and computational cost. Obviously, this requires that the read-back of temperatures and ion abundances is sufficiently good to give reasonable interpolations: less accurate read-backs mean, for example, that improvements by smarter interpolation schemes might become worthless.

Many different possibilities exist to get reliable read-backs of the control variables. For example, ion abundances can be collected from the detected mass spectrum, directly calculated from the first datapoints of the transient, measured from sideband distances, directly measured as the amplitude of the magnetron motion, or any combination of these and the regulation setpoint that experimentally proves to be useful. The temperature of the detection system (e.g. orbitrap) can be measured by a thermometer or derived from any other indicative physical property. If voltages are included in the correction scheme, they can be measured directly or indirectly, for example by measurement of Pockels, Kerr or Faraday effects caused by the voltage.

As will be appreciated by the person skilled in the art, variations may be made to the above embodiment without departing from the scope of the claims.

For example, the above embodiment is set in the specific context of FT-ICR-MS spectrometry, but the invention may be used with other types of mass spectrometry where assignment of masses to peaks appearing in the mass spectra is influenced by ion abundance. Such techniques include ion trap mass spectrometry, time of flight mass spectrometry (TOF-MS) including quadrupole TOF-MS (QTOF-MS), and Fourier Transform mass spectrometry (FTMS) in general and FT-Orbitrap-MS (FT-O-MS).

A specific scheme for automatic gain control is provided above, although the details of this may be varied. As will be clear, the goal is to obtain a mass spectrum with reduced errors in mass assignment because the additional mass correction achieved with the present invention works best when performing only small adjustments. This is due to the fact that interpolations work well over only small ranges: put another way, the larger the range the interpolation must span, the worse the end results.

The above embodiment uses the equation

$$m = \frac{A}{f} + \frac{B}{{f}^{2}}$$

as this works well with FT-ICR-MS. However, it is easy to apply the present invention to schemes using other equations, as will be evident from the Orbitrap example provided above. Other currently contemplated equations include those that follow the form

$$m = \frac{A}{f} + \frac{B}{{f}^{2}} + \frac{C}{{f}^{4}}$$

or series such as

$$m = \frac{A}{f} + \frac{B}{{f}^{2}} + …$$

When collecting the calibration data set, it is clearly important to calibrate peak positions against ion abundance but there is freedom of choice in choosing what other experimental parameters may be varied. It goes without saying that the more other parameters are calibrated against, the better the end results. However, in some cases the improvement in end result is marginal and will not justify the additional effort required in collecting the data and compiling the associated calibration data set.

In the above embodiment, the gradients are calculated and stored as part of the calibration data set. However, this need not be the case. Instead, just the coefficients A and B could be stored and the gradients could be calculated on the fly during a later mass-assignment correction stage.

The above calibration scheme may be implemented daily. In some circumstances, only one of the coefficients A is likely to vary appreciably on a day-to-day basis. In this case, a daily calibration to update the values of A may be performed. Values for B may be updated on an extended basis.

1. A method of improving a mass spectrum collected from a mass spectrometer comprising a detector for collecting a mass spectrum from ions stored in or released from an ion trapping volume, wherein assignment of masses to peaks appearing in the mass spectrum is sensitive to an experimental parameter related to the mass spectrometer or the operation thereof, the method comprising the steps of:
determining a positional value of at least one peak of the mass spectrum;
determining the experimental parameter associated with the mass spectrum; comparing the determined positional value with positional values of peaks contained in a calibration dataset that contains positional values for varying values of the experimental parameter; and
improving the determined positional value of the peak from adjacent peak positional values by interpolation thereby to provide a corrected mass assignment for the peak.

2. The method of claim 1, wherein the positional values are masses assigned to a peak.

3. The method of claim 1, wherein the positional values are frequencies of a peak.

4. The method of claim 1, wherein the positional values are coefficients of an equation linking the frequency of a peak to the mass of that peak.

5. The method of claim 4, wherein:
the equation is
$$m = \frac{A}{f} + \frac{B}{{f}^{2}} ,$$
where m is the mass, f is the frequency, and A and B are the coefficients;
the calibration data set comprising values for both coefficients A and B for different values of the experimental parameter.

6. The method of claim 5, wherein interpolation comprises calculating coefficients A′ and B′ by interpolation between coefficients A and B stored for close values of the experimental parameter and providing a corrected mass assignment comprises substituting the coefficients A′ and B′ into the equation
$$m = \frac{{A}^{′}}{f} + \frac{{B}^{′}}{{f}^{2}} .$$

7. The method of claim 4, wherein interpolation is performed using coefficients stored for values of the experimental parameter close to the determined value of the experimental parameter.

8. The method of claim 7, wherein interpolation is performed between coefficients stored for the values of the experimental parameter immediately greater and lesser than the determined value of the experimental parameter.

9. The method of claim 1, wherein the interpolation is selected from the list comprising: linear, cubic spline, B-spline, Akima, Thiele, rational and corresponding to the Chebychev approximation.

10. The method of claim 1, wherein the experimental parameter is selected from the list comprising: the ion abundance in the trapping volume, the temperature in the trapping volume, AC potentials applied to the trapping volume and DC potentials applied to the trapping volume.

11. The method of claim 1, preceded by: filling the trapping volume with ions according to a target ion abundance determined in accordance with automatic gain control; and acquiring the mass spectrum from the ions stored in or released from the ion trap so filled.

12. The method of claim 11, wherein determining the target ion abundance with automatic gain control comprises: filling the trapping volume for a predetermined time; measuring the total ion content of the trapping volume so filled; and comparing the measured total ion content to the target ion abundance and calculating an adjusted predetermined time to achieve the target ion abundance and wherein filling the trapping volume with ions according to a target ion abundance determined in accordance with automatic gain control comprises filling the trapping volume for the adjusted predetermined time.

13. The method of claim 11, comprising filling the trapping volume with ions to a maximum achievable abundance that is less than the target ion abundance, determining the fraction of the target ion abundance the maximum achievable abundance constitutes, scaling the target ion abundance according to the fraction, and using the scaled target ion abundance when comparing the determined positional value with positional values of peaks contained in the calibration dataset and improving the determined positional values by interpolation.

14. A method of calibrating a mass spectrometer comprising a detector for collecting a mass spectrum from ions stored in or released from an ion trapping volume, wherein assignment of masses to peaks appearing in the mass spectrum is sensitive to an experimental parameter related to the mass spectrometer or the operation thereof, the method comprising the steps of:
filling the trapping volume according to a first value of the experimental parameter;
acquiring a mass spectrum of ions in the trapping volume;
repeating filling the trapping volume to further values of the experimental parameter and acquiring a mass spectrum of ions in the trapping volume for at least one further value, thereby acquiring an array of calibration mass spectra;
determining positional values of at least one peak of the calibration mass spectra; and storing in a calibration data set positional values with the varying values of the experimental parameter.

15. The method of claim 14, wherein the positional values are masses assigned to a peak.

16. The method of claim 14, wherein the positional values are frequencies of a peak.

17. The method of claim 14, wherein the positional values are coefficients of an equation linking the frequency of a peak to the mass of that peak.

18. The method of claim 17, wherein:
the equation is
$$m = \frac{A}{f} + \frac{B}{{f}^{2}} ,$$
where m is the mass, f is the frequency, and A and B are the coefficients;
the calibration data set comprising values for both coefficients A and B for different values of the experimental parameter.

19. The method of claim 14, wherein the experimental parameter is selected from the list comprising: the ion abundance in the trapping volume, the temperature in the trapping volume, AC potentials applied to the trapping volume and DC potentials applied to the trapping volume.

20. The method of claim 14, wherein filling the trapping volume with ions is performed according to a target ion abundance determined in accordance with automatic gain control; and the mass spectrum is acquired from the ions stored in or released from the ion trap so filled.

21. The method of claim 20, wherein determining the target ion abundance with automatic gain control comprises: filling the trapping volume for a predetermined time; measuring the total ion content of the trapping volume so filled; and comparing the measured total ion content to the target ion abundance and calculating an adjusted predetermined time to achieve the target ion abundance and wherein filling the trapping volume with ions according to a target ion abundance determined in accordance with automatic gain control comprises filling the trapping volume for the adjusted predetermined time.

22. The method of improving a mass spectrum according to claim 1, wherein the calibration dataset is acquired and stored in accordance with the method of claim 14.

23. A mass spectrometer comprising an ion trapping volume, a detector for collecting a mass spectrum from ions stored in or released from an ion trapping volume, and a processor operable to assign masses to peaks appearing in the mass spectrum, wherein assignment of masses to peaks appearing in the mass spectrum is sensitive to an experimental parameter related to the mass spectrometer or the operation thereof, the processor being programmed to perform the steps of:
determining a positional value of at least one peak of the mass spectrum;
determining the experimental parameter associated with the mass spectrum; comparing the determined positional value with positional values of peaks contained in a calibration dataset that contains positional values for varying values of the experimental parameter; and
improving the determined positional value of the peak from adjacent peak positional values by interpolation thereby to provide a corrected mass assignment for the peak.

24. (canceled)

25. A computer program product comprising a computer readable medium having thereon program instructions operable when loaded into a processor of a mass spectrometer, the mass spectrometer also comprising an ion trapping volume, and a detector for collecting a mass spectrum from ions stored in or released from an ion trapping volume, the processor being operable to assign masses to peaks appearing in the mass spectrum, wherein assignment of masses to peaks appearing in the mass spectrum is sensitive to an experimental parameter related to the mass spectrometer or the operation thereof, to cause the processor to perform the steps of:
determining a positional value of at least one peak of the mass spectrum;
determining the experimental parameter associated with the mass spectrum;
comparing the determined positional value with positional values of peaks contained in a calibration dataset that contains positional values for varying values of the experimental parameter; and
improving the determined positional value of the peak from adjacent peak positional values by interpolation thereby to provide a corrected mass assignment for the peak.
